(19) United States
(12) Patent Application Publication
(10) Pub. No.: US 2002/0104848 A1
(43) Pub. Date: Aug. 8, 2002

(54) Pharmaceutical container having signaling means and associated method of use

(76) Inventors: Mark D. Burrows, Villanova, PA (US); Peter A. Basile, Bloomsbury, NJ (US)

Correspondence Address: David C. Jenkins, Eckert Seamans Cherin & Mellott, LLC, 44th Floor, 600 Grant Street, Pittsburgh, PA, 15219, US

(21) Appl. No.: 09/776,983

(22) Filed: Feb. 5, 2001

(51) Int. Cl. G07F 11/00

(52) U.S. Cl. 221/1

(57) ABSTRACT

A container having signaling capability is disclosed for use with medicine and other pharmaceutical related products. The container preferably includes a conventional bottle-type body with a rotatably secured closure. A sensor means is structured to determine the position of the closure and thereby provide an indication of cap rotation indicative of the patient using the medicine. A processing means and display means are also included in the container to provide an indication of the current state of the container with respect to its contents. In addition, the container can include a button means to permit a user of the container to scroll through indicia shown on the display means. In another aspect of the container, a base station is provided for transmitting data to/from a signal means incorporated into the container. The base station includes a body having at least one receptacle for suitably receiving a container therein. A method of using the container is also provided.

### BACKGROUND OF THE INVENTION

1 Field of Invention

This invention relates to containers for medicine and, more specifically, to a container for medicine which incorporates a compliance device for reminding the user to take the medicine contained within the container.

2 Background Information

The prevalence of the use of medicine in a modem society cannot be overstated. Medicines are used by persons of all ages to treat simple illnesses to life threatening diseases. Often, a variety of medications will be required to treat a single illness. Successful treatment of such medical conditions through the use of medication depends on the patient taking the prescribed dose of medication according to a prescribed schedule. Failure to comply with the prescribed schedule reduces the effectiveness of the medicine and may prolong the treatment. Given the complexity of dosage schedules and/or the number of medications being taken, not to mention the fact that the patient may be impaired by the illness or as a side effect of the medication, it is desirable to have a device to remind the patient when to take a dose of a medicine.

Medication compliance devices are known in the prior art. A medication compliance device or system is a device designed to manage the medication regimen of a patient. The compliance device typically tracks the type of medication(s) the patient is taking and reminds the patient to take a dose of the medicine according to the schedule prescribed by a physician. Some compliance devices use programmable computers to track the type of medication and dosage schedule for an individual patient. The compliance device may, for example, include a container coupled to a computer operated control device. The control device opens the container on a prescribed schedule to allow the patient access to the medicine. The device may also include a camera, or other such device, to record compliance by the patient. Other systems include a “beeper” like device which is activated according to the prescribed schedule. When the beeper alarm sounds, the patient is reminded to take the medicine. The disadvantage of the former system is that it is too large to be easily carried by the patient. The disadvantage of the latter system is that the beeper unit is not coupled to the medicine container and, as such, the user may forget to carry both the beeper and the medicine container. Additionally, the beeper system fails to track whether the patient takes the medicine. Of course, such a system could incorporate a system wherein the patient actively inputs when a medicine is taken. Additionally, these systems generally require the patient to input information including, but not limited to, the time of the initial dose.

An improved compliance device is disclosed in U.S. Pat. No. 5, 495, 961. This device includes container holder which incorporates a display/alarm device. The display/alarm device is programmable according to a prescribed schedule. The container for the medicine is inserted into the holder, thereby ensuring the medicine and alarm are in proximity to each other. There are several disadvantages to this device as well. For example, the device does not provide a means for tracking compliance by the user. Also, when a patient has more than one prescribed medicine, the wrong medicine bottle could be inserted in the holder resulting in the patient taking a first medicine according to the schedule for a second medicine.

Another compliance device, disclosed in U.S. Pat. No. 4, 617, 557 utilizes a blister pack design, e.g. a plastic cover and foil backing which requires the patient to push a pill through the foil in order to remove the pill. The blister pack includes a control module having a display/alarm as well as a system of conductive pathways, i.e. wires, disposed within non-conductive layers adjacent to the foil. The display alerts the patient when a pill should be taken. Additionally, as the patient breaks the foil, the electronic connection associated with that pill location is severed. The control module records when a pill is removed from the system. There are several disadvantages to this device as well. The monitoring system is always “on” and therefore a constant drain on the battery of the control module. The device also requires additional non-conductive layers between the plastic cover and the foil. These layers make the, often difficult, task of opening the blister package more burdensome. Moreover, this system is only functional with medicines that are packaged in a blister pack.

There is therefore a need for a medicine container having an integral compliance device.

There is a further need for a medicine container that passively tracks patient's compliance with a dosage schedule.

There is a further need for a medicine container having an integral compliance device that is structured to communicate with an electronic medium which is also accessible by a physician, physician or other medical aid personnel.

There is a further need for medicine container having an integral compliance device that is ready for use by the patient without having the patient actively input any information.

There is a further need for a method of using a medicine container having an integral compliance device.

There is a further need for a method of manufacturing for a medicine container having an integral compliance device.

### SUMMARY OF THE INVENTION

These needs, and others, are satisfied by the invention which provides a container having signaling capability structured for use with medicine and other pharmaceutical related products. The container preferably includes a conventional bottle-type body with a rotatably secured closure. A sensor means is structured to determine when the closure opens and closes thereby providing an indication of use. A processing means and communication means are also included in an electronic module in the container. The display provides an indication of when the patient should take the medicine, if the patient missed the most recent dose, and provides a warning of a possible double dose.

The processing means is coupled to the sensor and tracks when the container is opened and closed. As such, the compliance device operates without active input from the patient. In addition, the container may include a button means to permit a user of the container to scroll through indicia related to the medicine on the communication means. In another aspect of the invention, a base station is provided for transmitting data to/from a signal means incorporated into the container. The base station includes a body having at least one receptacle for suitably receiving a container therein. A method for manufacturing and a method for using the container is also provided.

### BRIEF DESCRIPTION OF THE DRAWINGS

A full understanding of the invention can be gained from the following description of the preferred embodiments when read in conjunction with the accompanying drawings in which:

FIG. 1 is an isometric view of a screw top bottle embodiment.

FIG. 2 is an isometric view of a base station.

FIG. 3 is a flowchart showing the electronic module functions.

FIG. 4 is an isometric view of a snap fit bottle embodiment.

FIG. 5 is an isometric view of a flip top bottle embodiment.

FIG. 6 is an isometric view of a screw top bottle with a spray nozzle.

FIG. 7 is an isometric view of a atomizer embodiment.

FIG. 8 is an isometric view of a blister pack embodiment.

FIG. 9 is an partial cross-sectional view of the blister pack embodiment.

FIG. 10 is an isometric view of a box embodiment.

FIG. 11 is an isometric view of a dual flap, flip top bottle.

### DETAILED DESCRIPTION

As used herein, “medicine” includes pharmaceutical products, vitamins, minerals, steroids, and drugs in any form, including, but not limited to, pills, liquids, tablets, injectable fluids, eye drops, cremes, powders, caplets, other oral dose forms, and topical medications.

As used herein, “patient” includes aids, nurses, health care practitioners and other medical personnel or assistants who help the person who is ill. Except, of course, when a statement refers to a patient taking a medicine, which must be performed by the person who is ill.

Generally, the container of the present invention includes a sensor which passively senses when the container is opened and closed. The sensor is coupled to an electronic module. The electronic module is encoded with a dosage schedule. The electronic module further includes a clock and a communication means, such as a display and/or speaker. By comparing data from the clock to the dosage schedule, the electronic module shows a countdown to the next scheduled dosage. The container may be a bottle with a screw top, a bottle with a snap-fit lid, a dropper, a blister pack, a box for medicines in the form of parenteral devices, powders topical cremes, or an atomizer. The battery for the electronic module is of a reduced size because the sensor only operates when the container is opened and closed, rather than constantly sensing the state of the container. Individual embodiments are described below.

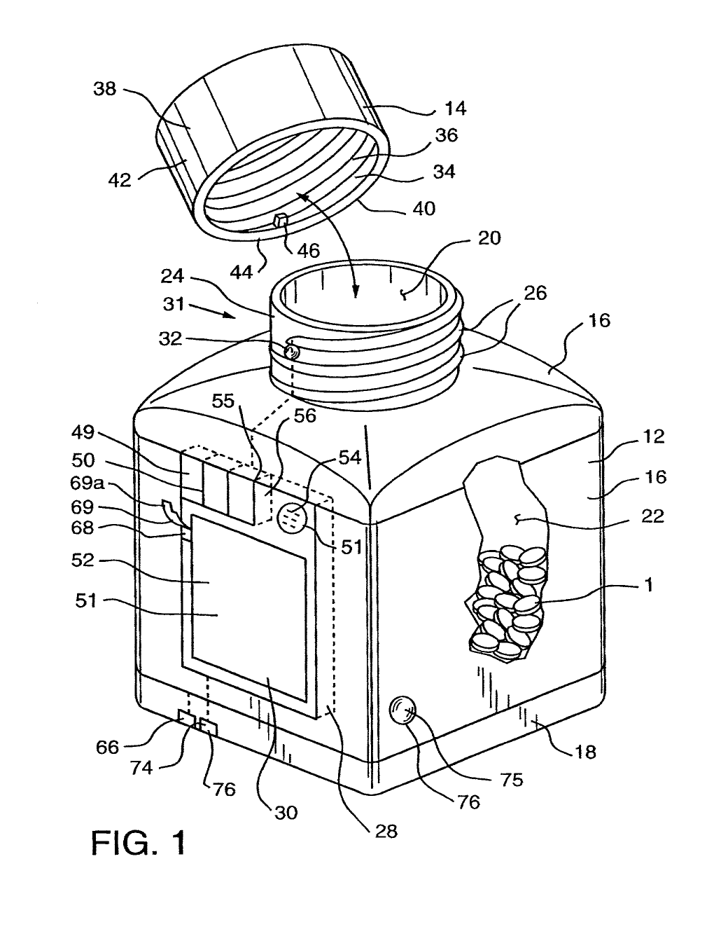

As shown in FIG. 1, in one embodiment, a container 10 includes a housing 12 and at least one closure 14. As described below, the closure 14 moves between a first, closed position wherein the closure 14 engages the housing 12, and a second, open position, wherein the closure 14 does not engage the housing 12. The housing 12 includes a wall 16 having a top end 18 and a bottom end 20. The wall 16 may be any shape, however, a four sided housing is preferred. The wall 16 defines a cavity 22. The wall 16 includes at least one opening 20, preferably disposed near the top end 18. A collar 24 is disposed about opening 20. The collar 24 includes integral threads 26. At least one outwardly opening recess 28 is formed in wall 16. An electronic module 30 is structured to fit within recess 28. A sensor means 31, such as a dome switch 32, is disposed between the collar threads 26. The sensor means 31 is structured to detect when the closure 14 moves between the open position and the closed position. The sensor means 31 produces an electronic signal and is in electronic communication with the electronic module 30. A medicine 1 is disposed within cavity 18.

The closure 14 includes a body 34 having a planar member 36 and a generally perpendicular sidewall 38 extending therefrom. The planar member 36 has a size and shape corresponding to collar 24. The sidewall 38 has an inner side 40 and outer side 42. The sidewall inner side 40 includes closure threads 44 which are structured to engage collar threads 26. An actuator 46 is disposed between closure threads 44. The actuator 46 is, preferably, a rigid member that is structured to interact with the dome switch 32 as the closure 14 moves between the open position and the closed position.

The electronic module 30 includes a processing means 49, such as a programmable CPU with associated memory 50, a communications means 51, such as display 52 and/or speaker 54. The processing means 49 includes a data storage means 55, such as random access memory 56, a controller means 57, such as an integrated circuit controller 58, a timing means 59 such as a clock 60, a sensor interface 62, and a communication interface 64. The electronic module 30 may also include a linkage to a signaling/receiving means 65, such as contacts 66. The signaling/receiving means 65 may also be a wireless means such as a transmitter and antennae 67. The data storage means 55, timing means 59, sensor interface 62, communication interface 64, and signaling/receiving means 65 are in electronic communication with the controller means 57. The communication interface 64 is also in electronic communication with display 52 and/or speaker 54. The sensor interface 62 is in electronic communication with the sensor means 31.

The electronic module 30 is powered by a battery 68. Because the sensor circuit is only closed when the closure 14 is moved between the open and closed positions, the sensor circuit is not a constant drain on the battery 68. Initially, the circuit which includes the battery 68 is maintained as an open circuit by a non-conductive material 69 disposed between the battery the other parts of the circuit. The non-conductive material 69 has a tab 69a that extends outwardly so that the tab 69a may be easily grasped. When the electronic module 30 is ready to be used, an operator, typically a pharmacist, pulls on the tab 69a and thereby removes the non-conductive material 69. When the non-conductive material 69 has been removed, the circuit which includes the battery 68 is closed. Alternatively, the electronic module 30 may include an on/off switch means, such as a dual pin/jumper switch 169. When the electronic module is ready to be used, an operator, typically a pharmacist, moves the jumper 169a from one pin 169b and replaces the jumper 169a over both pins 169b, 169c. When the jumper 169a is placed over both pins 169b, 169c, the power circuit is closed and the electronic module 30 receives power. Power to the electronic module 30 may be terminated by opening the power circuit, for example, by removing jumper 69a.

The display 52 is, preferably, a liquid crystal display (“LCD”). The display 52 is structured to indicate data in a form readable by the patient, including, but not limited to, showing time until the next scheduled dose, indicating a prescribed time to dose, verifying dose was taken, notifying of missed dose along with a suggested corrective action, warning of a possible double dose, the position of the closure 14, and indicating whether the processing means 49 has engaged in data-transmission.

The data storage means 55 is structured to store data representative of information relating the medicine 1 contained in the container 10, the prescribed schedule for the patient, and the dispensing history. The controller means 57 is structured to receive data from the signaling/receiving means 65 and store such data in the data storage means 55 or display such data on the display 52. The controller means 57 is further structured to compare data, such a dosage schedule, to data provided by the clock 60 and provide information, e.g. a countdown to the next scheduled dosage, to the display 52. The controller means 57 is further structured to receive input from the sensor interface 62 and relate that data to input from the clock 60. The controller means 57 then stores the sensor interface/clock data in the data storage means 55. The sensor interface/clock data is an indication of the dispensing history, indicating when the patient opened and closed the container 10.

The electronic module 30 is coupled to a label 70. The label 70 includes an adhesive (not shown) to secure the label 70 to the housing 12. The label 70 includes indicia 72, such as a scanable symbol, e.g. a UPC code, writing or diagrams relating to the use of medicine 1 or use of the electronic module 30. The label 70 also includes an identification number 74. In a preferred embodiment, the label 70 also includes a user control means 75, such as a label dome switch 76. The label dome switch 76 is coupled to the controller means 57. When the label dome switch 76 is activated, the controller means 57 will cause the display 52 to show different information (as described below). For example, the display 52 will typically show the countdown until the next scheduled dose. When the label dome switch 76 is activated, the display 52 may show the time the container was last opened. If the label dome switch 76 is activated again, the display 52 may show information relating to the medicine, such as warnings. If the label dome switch 76 remains unactivated for a period of time, the display 52 returns to a display of the name of the medicine. When the next scheduled dose is within thirty minutes, the display 52 shows a countdown until the next scheduled dose.

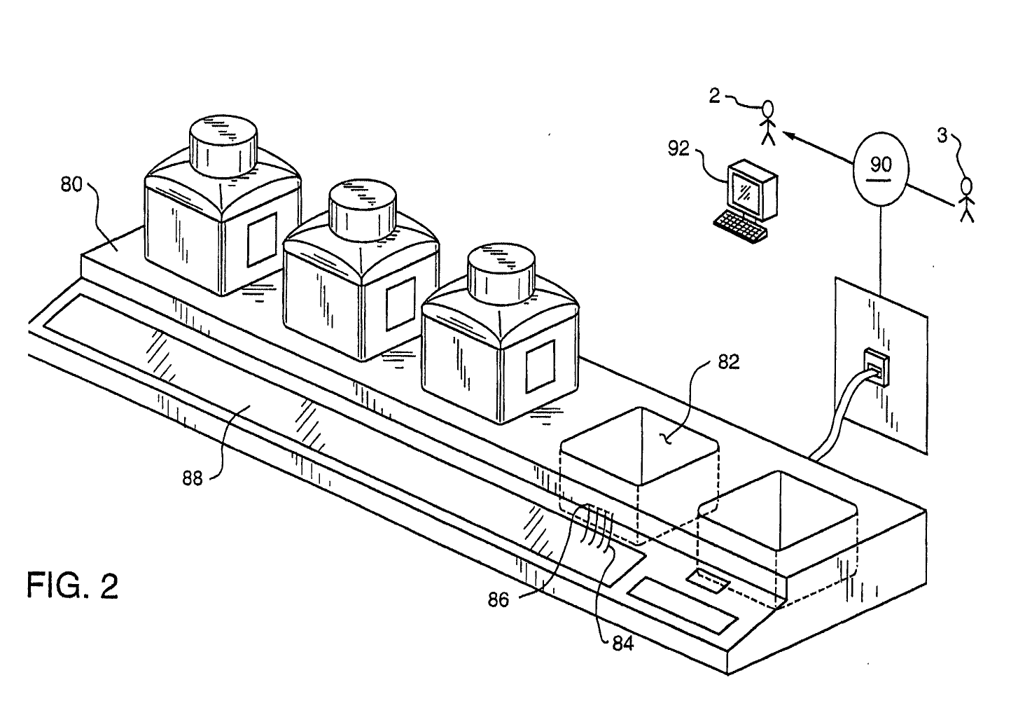

A base station 80, as shown in FIG. 2, is structured to have at least one receptacle 82 formed therein. The receptacle 82 is sized to hold a container 10. The base station 80 is used to program the electronic module 30. The electronic module 30 is programmed through the signaling/receiving means 65. The signaling/receiving means 65, for example may include a data input port 74 and a data output port 76. Within the receptacle 82, a data input port 84 and a data output port 86, which correspond to container data input port 74 and container data output port 76, are disposed. The base station 80 further includes an electronic communication means 87, such as a modem 88, that enables the base station 80 to communicate data to/from a communications medium, such as the Internet. Alternately, the electronic communications means 87 could be an input/output 88'device, such as an network “card,” that is in communication with a local area network. The electronic communications means 87 can also be structured to contact the patient via a communications device such as a pager or a telephone.

In operation, the housing 12 and closure 14 are provided as described above. However, the electronic module 30 is not inserted into the recess 28, the label 70 is not coupled to the electronic module 30 and the data storage means 55 does not contain data related to a patient or a medicine 1. The power circuit is closed as described above and battery 68 is coupled to the electronic module 30. The label 70 is then encoded with the identification number and then the label 70 is coupled to the electronic module 30. The electronic module 30 is the disposed in the recess 28 in the housing and the sensor means 31 is coupled to the electronic module 30. The electronic module 30 is secured in the recess 28 by adhering the label 70 to the housing 12.

Separately, a schedule of use for the medicine 1 is determined. Preferably, the determination of the schedule of use includes a physician prescribing the use of the medicine 1. The determination of the schedule of use, however, may be determined by others, such as the manufacturer of a non-prescription medicine 1. The schedule of use is then encoded into the electronic module 30. The encoding of the electronic module 30 is performed using a base station 80 that is, preferably, located at a pharmacy. Alternatively, certain medicines, even prescription medicine, may have dosage schedule that is independent of the patient, e.g. once per day. Containers of such medicines may be filled and programmed at the manufacturer or at a filling operation. A filling operation is a manufacturing facility structured to fill containers 10 with medicine 1. The filling operation also include larger base stations 80 structured to receive many containers 10 or the base station 80 may be part of an assembly line structured to program multiple containers 10.

The housing 12 is then filled with the medicine 1. Tracking of which medicine 1 belongs in the housing 12 is accomplished using the label 72 identification number and/or the electronic module 30. The housing 12 is then coupled with the closure 14. As the closure 14 is joined with the housing 12, the actuator 46 interacts with the switch means 31 causing a signal to be communicated to the controller means 57. The controller means 57 stores the time the container 10 was first closed in the data storage means 55. The container 10 is then delivered to the patient.

The next time the container 10 is opened, the actuator 46 will interact with the sensor means 31 and the time of the sensor input will be recorded by the controller means 57 in the data storage means 55. Presumably, this is the time the patient will be taking the medicine 1. As the container 10 is closed, the actuator 46 will again interact with the sensor means 31 and the time of the sensor input will be recorded by the controller means 57 in the data storage means 55. The controller means 57 will use this time to start the countdown to the next dosage. The name of the medicine or a countdown to the next scheduled dosage will be shown on the display 52 as described above. When the countdown is complete, the display 52 will indicate that it is time for another dosage. Additionally, the speaker 54 may sound an alarm. The countdown to the next dose is reset after the controller means 57 receives input from the sensor means 31 indicating the container 10 has been opened and closed. In the event the container 10 is not opened and closed at the time of a scheduled dosage, the display 53 will show a message that a dosage was missed and indicate the corrective course of action. Additionally, the speaker 54 may sound an alarm, for example one beep every second for ten seconds, repeated every minute. An alarm may also warn of a possible double dose.

The base station 80 communicates with an electronic medium, such as the Internet. The base station 80 is connected to a patient database 90. Both physicians 2 and pharmacists 3 may access the patient database 90, either through a base station 80 or through a computer 92. In operation, the physician 2, or his/her agent, enters a prescription in to the database 90. When a patient is at a pharmacy, the pharmacist 3 will access the database 90 to obtain the prescription information. After the information is received, the container 10 is prepared as detailed above. Additionally, when a patient returns for a refill on the prescription, or upon directions from the physician 2, the container 10 may be reinserted into the base station 80. At this time, the base station 80 will access the dispensing history stored in the data storage means 55 of the electronic module 30. The dispensing history is then communicated to the patient database 90 where a physician 2 may review the dispensing history. Additionally, when the patient receives prescriptions from different physicians 2, or if the patient uses over-the-counter medicines, where the other medicine is stored in a similar container, the dispensing history of each medicine will be stored in the patient database 90. The dispensing history for multiple medicines may be used to diagnose and/or prevent improper drug interactions.

The base station 80 may also be provided to patients. A patient may store one or more containers 10 in the base station 80. The base station communications means 87 can be structured to contact the patient database 90 at a specified interval, e.g. once per day. The patient's compliance with the schedule can thus be monitored on a daily basis. The database 90, in cooperation with a communications program, can be structured to provide reminders to patients, e.g. via a display on the base station 80 or via e-mail, when the patient fails to take a scheduled dosage. Alternatively, the database 90 may be structured to provide the physician 2 or another person or service with information to foster compliance by the patient.

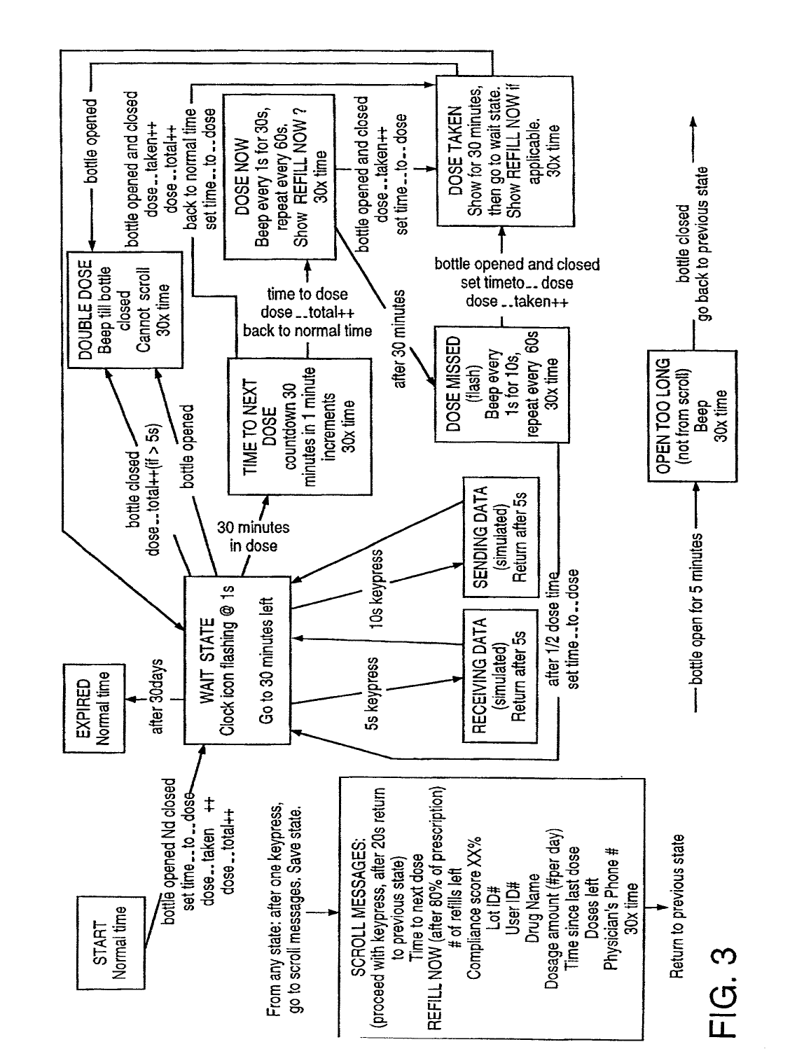

The communications means 51, in combination with the processing means 49, may provide additional information to the patient. For example, as shown on FIG. 3, In addition to a countdown to the next scheduled dose, the communications means, through speaker 54 will sound an alarm once per second for thirty seconds at the time the dose should be taken. The alarm will repeat every sixty seconds until the container 10 is opened. As described above, opening and closing the container 10 will reset the countdown. If the container 10 is opened within a certain time period, more than thirty minutes before a scheduled dose for example, the communications means 51 will sound an alarm on speaker 54 and show a “Double Dose” warning on display 52. If the container 10 is open for more than a certain period of time, for example 5 minutes, the display 52 will show an “Open Bottle” warning. The communications means 51 may also provide a warning when the supply of medicine 1 is low, for example, less than 80% of the supply. Such a warning will direct the patient to obtain a refill, if prescribed, and the number of refills remaining in the prescription. The communication means 51 may also provide warnings for a low battery and an expiration of the medicine 1. The communications means 51 may also provide additional information such as a compliance score, i.e. a percentage of times the patient took the dosage on schedule, the time the last does was taken, total number of days the electronic module 30 has been in use, number of doses remaining in the container 10, the physician's phone number, pharmacist's phone number, lot ID # for the medicine, and other such information. Such additional information is shown on the display 52 in response to input from the label dome switch 76. Any displayed message may be accompanied by a alarm on the speaker 54.

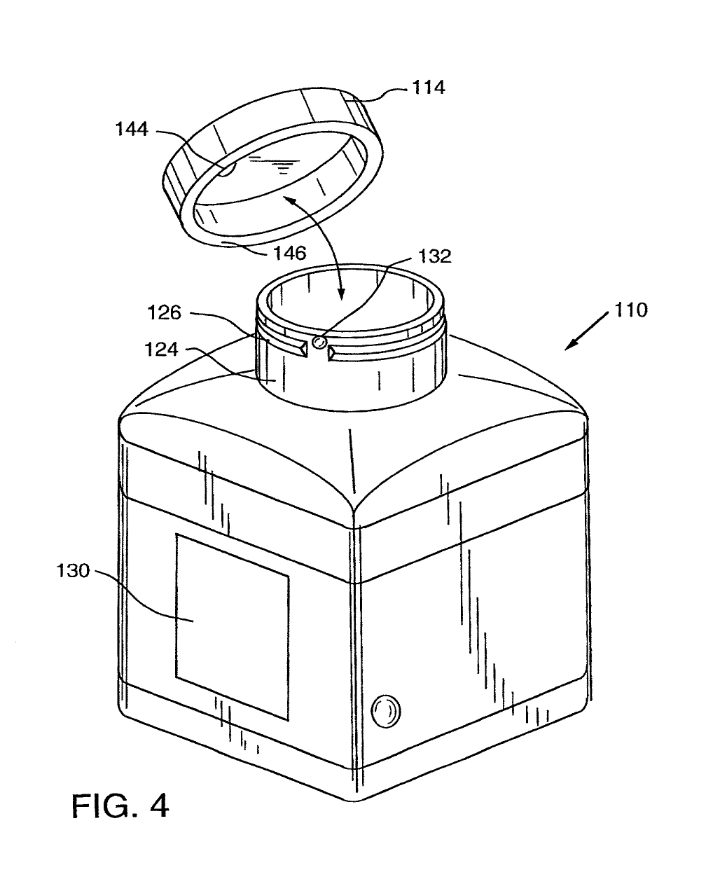

A second embodiment is shown in FIG. 4. This container 210 is substantially similar to the embodiment described above, except the threaded closure 14 is replaced with a snap-fit closure 114. The closure includes a discontinuous flange 144 instead of threads 44. Similarly, the collar 124 is adapted to engage the snap fit closure 114 and, therefor includes a single corresponding discontinuous flange 126 rather than threads 26. The dome switch 132 is disposed on the collar 124 at a location where the closure discontinuous flange 144 will contact the dome switch 132 as the closure 114 is removed from the housing 112. Essentially, the closure discontinuous flange 144 acts as the actuator 146. The remaining aspects of the invention, including the electronic module 130 and the base station 80, are identical to the invention as described above.

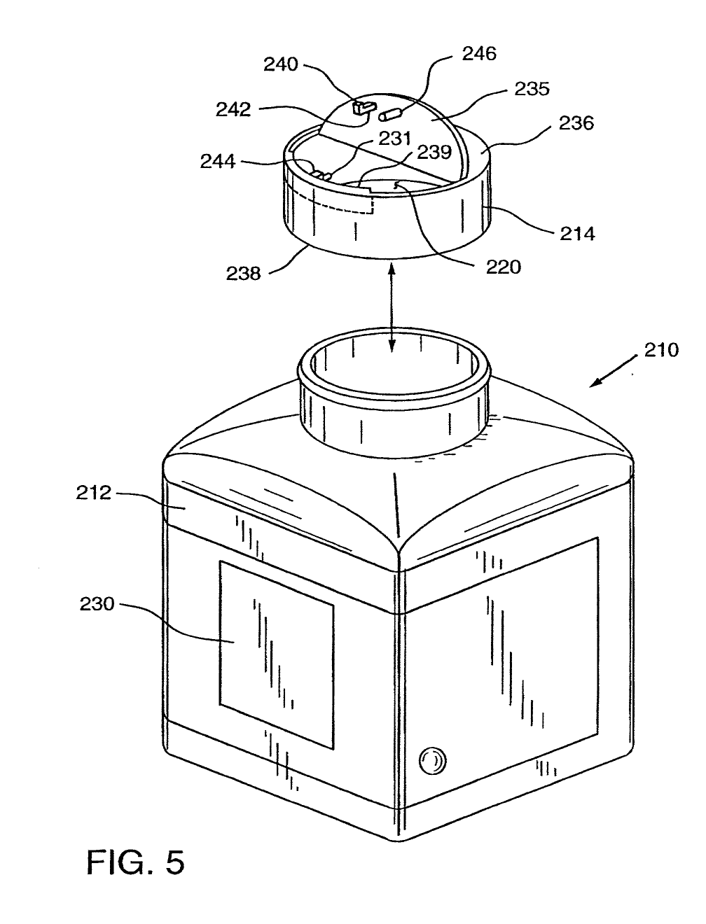

A third embodiment is shown in FIG. 5. This container 210 is substantially similar to the embodiment described above, except the snap-fit closure 114 is replaced with a flip top closure 214. The flip top closure 214 is coupled to the housing 212, for example, by a snap fit or other means. The flip top closure 214 has a planar member 236, a sidewall 238 having an opening 220. A portion of planar member 236 is formed as a movable flap 235. The movable flap 235 is hingedly connected to the planar member 236. The movable flap 235 moves between a first, closed position wherein the movable flap 235 covers opening 220 and a second, open position, wherein the movable flap 235 does not cover opening 220. The movable flap 235 is maintained in the closed position by a latch means 240. The latch means 240 is typically a projection with a shallow hook 242. The sidewall 238 includes a ledge 244 structured to interact with the shallow hook 242. The switch means 231 is disposed on a stationary portion of the ledge 244 adjacent to the latch means 240. The actuator 246 is a rigid member that extends from the inner side of the movable flap 235. As the movable flap 235 is opened and closed, the actuator 246 engages the switch means 231. The remaining aspects of the invention, including the electronic module 230 and the base station 80, are identical to the invention as described above.

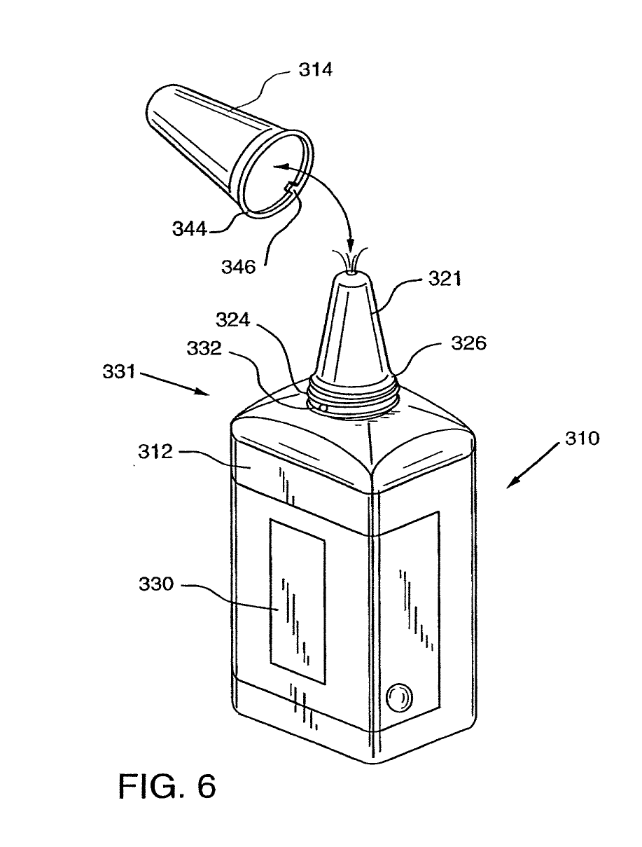

A fourth embodiment is shown in FIG. 6. This container 310 is substantially similar to the container 10 shown in FIG. 1 and described above. In this embodiment, however, the container 310 is structured primarily to contain a liquid. To that end, the opening (not shown) is covered by a nozzle 321 disposed on the collar 324. The collar 324 includes external threads 326. The closure 314 is structured to cover the nozzle 321. The closure 314, as before, includes a threaded portion 344 and an actuator 346. The housing 312 includes a switch means 331, such as a dome switch 332, disposed among the collar threads 326. The remaining aspects of the invention, including the electronic module 330 and the base station 80, are identical to the invention as described above.

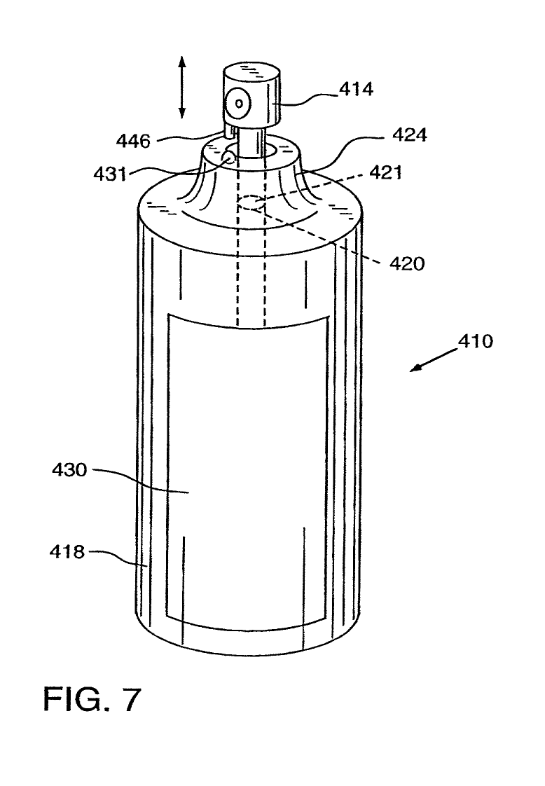

A fifth embodiment is shown in FIG. 7. This container 410 is structured as an atomizer for spraying a liquid medicine. The atomizer container 410 includes a housing 412 having a top end 416 and a bottom end 418. An opening 420 is located in the housing top end 418. The opening 420 defines a plane 421. The opening 420 is, preferably, surrounded by a collar 424. The opening 420 is sealed by a spray nozzle closure 414. The spray nozzle closure 414 is structured to move in a direction generally perpendicular to the plane of the opening 420. The spray nozzle closure moves from a first position, distal to the opening 420, to a second position, adjacent to the opening 420. A valve (not shown) is disposed within the spray nozzle closure 414. As is know in the prior art, as the spray nozzle closure 414 moves between the first and second position, a quantity of liquid medicine passes through the valve and is atomized before leaving the spray nozzle closure 414 as a mist. A switch means 431 is disposed on the collar 424. An actuator 446 extends from the bottom of the spray nozzle closure 414. When the spray nozzle closure 414 is in the second position, the actuator 446 engages the switch means 431. The remaining aspects of the invention, including the electronic module 430 and the base station 80, are identical to the invention as described above.

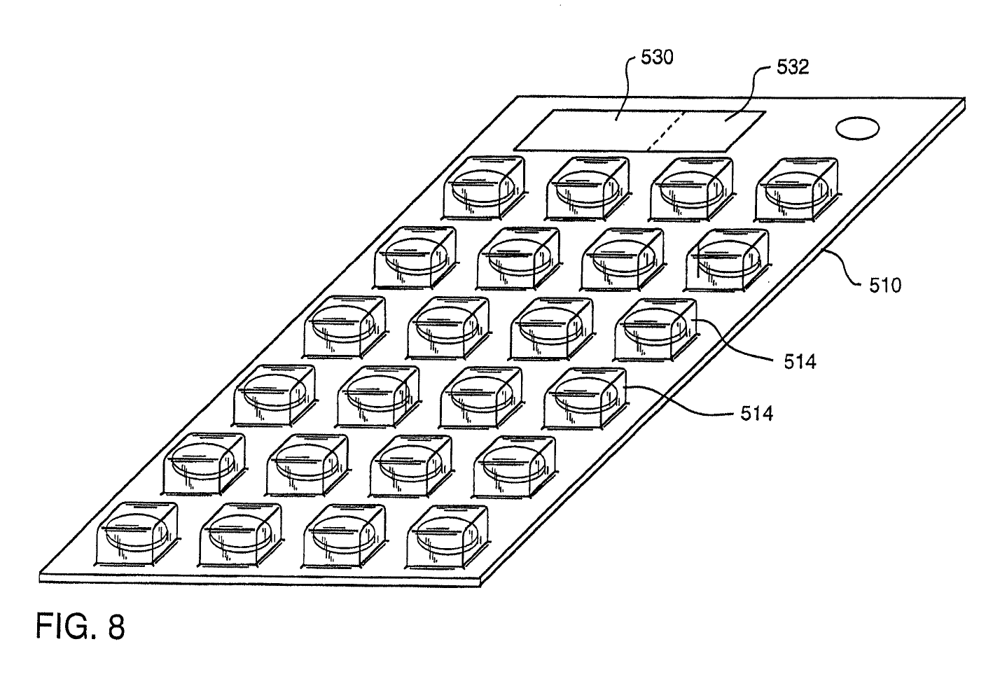

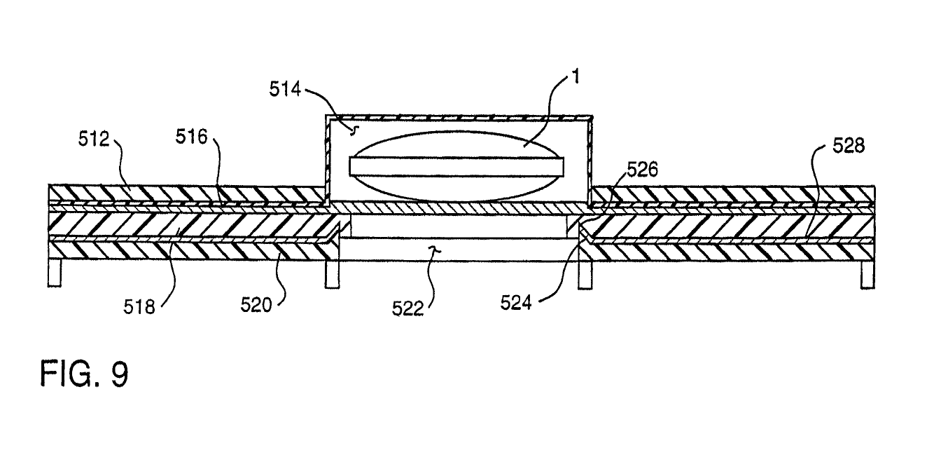

A sixth embodiment is shown in FIGS. 8 and 9. In this embodiment, the container 510 is a blister pack. The blister pack container 510 includes a first plastic layer 512 having a plurality of pockets 514 sized to contain one or more medicine pills or tablets 1. The pockets 514 in the first plastic layer 512 are sealed with a layer of conductive foil 516. Adjacent to the conductive foil 516, on the side opposite the first plastic layer 512, is a spring action cell foam 518. The spring action cell foam 518 is further adjacent to a second plastic layer 520 so that the spring action cell foam 518 is sandwiched between the first and second plastic layers 512, 520. Both the second plastic layer 520 and the spring action cell foam 518 include a plurality of pill openings 522 which correspond to the locations of the pockets 514 in the first plastic layer 512. Each of the pill openings 522 has at least one time 524 projecting into the spring action cell foam 518 toward the fist plastic layer 512. The tips of the tines 524 include a conductive surface 526. The conductive surface 526 is further coupled to a wire 528. Both the conductive foil 516 and the conductive surface 526 are coupled to an energy source 529. Because the conductive foil 516 and the conductive surface 526 are normally in a spaced relationship, being held apart by the spring action cell foam 518, the circuit formed by the energy source, the conductive foil 516 and the conductive surface 526 is an open circuit. When the patient pushes a pill out of the pocket 514, the first and second plastic layers 512, 520 will deform until the conductive foil 516 contacts the conductive surface 526. When the conductive foil 516 contacts the conductive surface 526, the circuit formed by the energy source, the conductive foil 516 and the conductive surface 526 is closed. A sensor means 531 is coupled to the circuit to detect when the circuit closes.

After a pill has been removed from a pocket 514 and the patient releases pressure on the container 510, the spring action cell foam 518 causes the conductive foil 516 and the conductive surface 526 to separate, thereby opening the circuit. As before, the sensor means 531 transmits a signal to the electronic module 530 indicating that the container 510 has been opened. In this embodiment, however, the countdown is reset after a single input from the sensor means 531 as this container 510 is not subsequently closed.

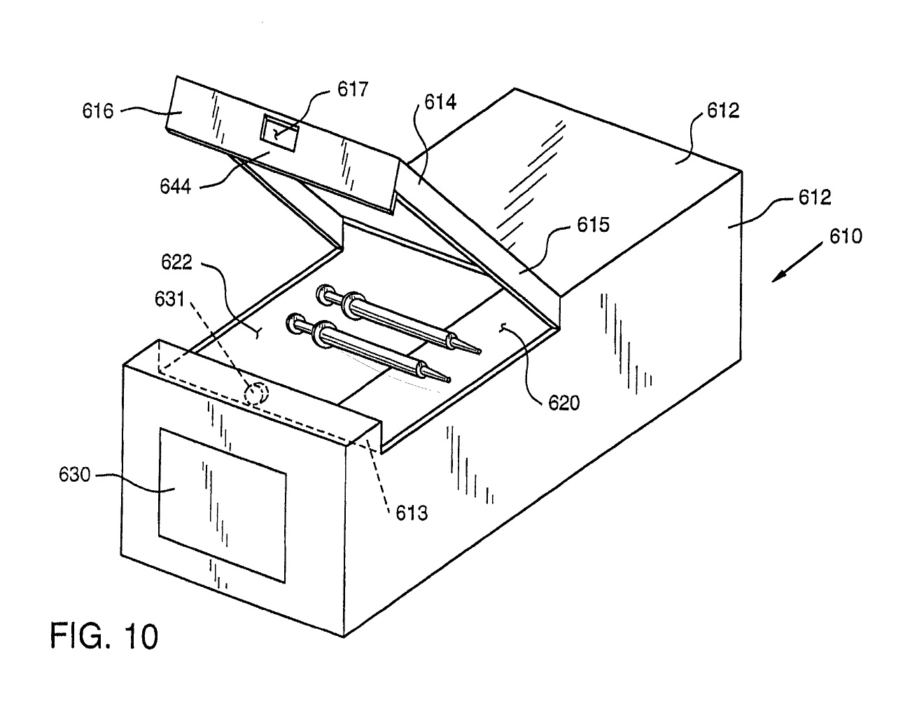

A seventh embodiment is shown in FIG. 10. This container 610 is, generally, a box that contains a plurality of parenteral devices, such as, but not limited to, syringes, suppositories, or dermal patches. The box container 610 has a plurality of side members 612 defining a cavity 622. One side member 612 includes an opening 620, and extension 613. The extension 613 is adjacent to the opening 620 and extends into the cavity 622. A flap closure 614 is coupled to a side member and is disposed adjacent to the opening 620. The flap closure 614 includes a first member 615 and a second member 616. The first and second members 615, 616 are coupled to each other at a generally right angle. The first member 615 is coupled to the side member 612. The second member 616 is coupled to the first member 615 and has an unattached distal end. The second member further includes a slot 617. The flap closure 614 moves between a first, closed position wherein the flap closure 614 covers opening 620 and a second, open position, wherein the flap closure 614 does not cover opening 620. The flap closure 614 is maintained in the closed position by friction between the extension 613 and the second member 616. A sensor means 631, such as a dome switch, is coupled to the extension 613. When the flap closure 614 is in the closed position, the sensor means 631 is disposed within slot 617. The portion of the second member 616 between the slot 617 and the distal end of the second member 616 acts as the actuator 644. As the flap closure 614 moves between the first and second position, the actuator 644 moves across the sensor means 631 activating the switch. The remaining aspects of the invention, including the electronic module 630 and the base station 80, are identical to the invention as described above.

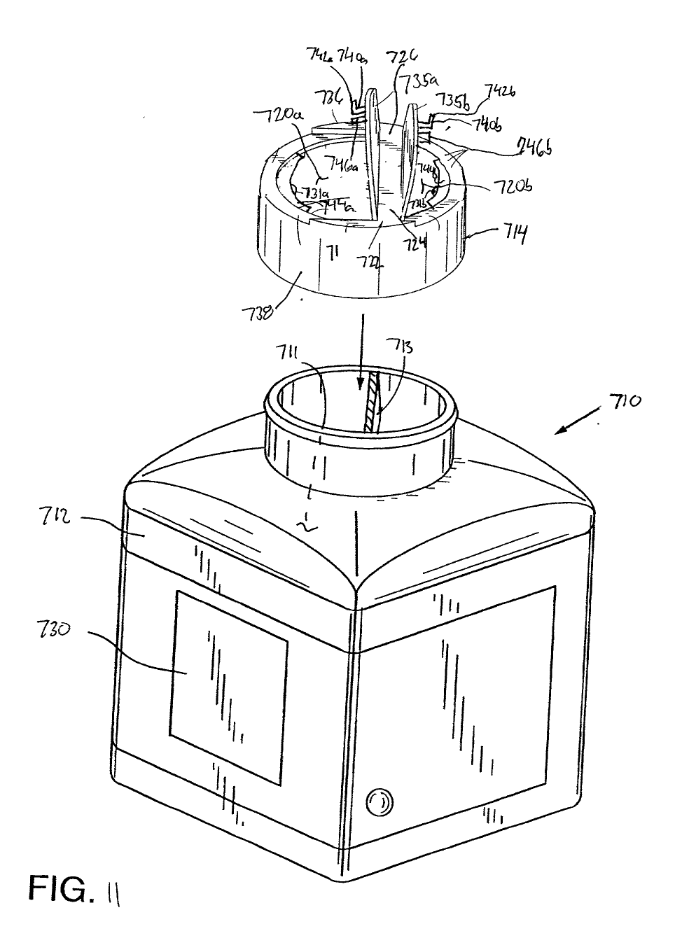

An Eighth embodiment is shown in FIG. 11. There are times when different dosages of a single medicine are prescribed for a patient. For example, a patient may take two pills in the morning and three pills at night. This container 710 is substantially similar to the flip top embodiment 210 described above, except the flip top closure 214 having a single movable flap 235 has been replaced with multiple flip top closure 714 having at least two separate movable flaps 735a and 735b. The separate movable flaps 735a and 735b may be of different sizes. The multiple flip top closure 714 is coupled to a housing 712. The housing 712 defines a cavity 711. The multiple flip top closure 714 has a planar member 736, and a sidewall 738 having two openings 720a, 720b. A hinge support member 722 having two ends 724, 726 extends between openings 720a and 720b. Each hinge support member end 724, 726 is attached to side wall 738. At least two portions of planar member 736 are formed as a movable flaps 735a, 735b. The movable flaps 735a, 735b are hingedly connected to the hinge support member 722. The movable flap 735a, 735b each move between a first, closed position wherein the movable flap 735a, 735b covers an opening 720a, 720b, respectively, and a second, open position, wherein the movable flaps 735a, 735b do not cover openings 720a, 720b. Each movable flap 735a, 735b is maintained in the closed position by a latch means 740a, 740b respectively. Each latch means 740a, 740b is typically a projection with a shallow hook 742a, 742b, respectively. The sidewall 738 includes two ledges 744a, 744b disposed within openings 720a, 720b respectively. Each ledge 744a, 744b is structured to interact with the shallow hook 742a, 742b respectively. A switch means 731a, 731b is disposed on a stationary portion of each ledge 744a, 744b adjacent to each latch means 740a, 740b. Each switch means 731a, 731b has an associated actuator 746a, 746b which is a rigid member that extends from the inner side of the movable flap 735a, 735b, respectively. As each movable flap 735a, 735b is opened and closed, the actuator 746a, 746b engages the associated switch means 731a, 731b. Both switch means 731a, 731b is coupled to an electronics module 730. The remaining aspects of the invention, including the electronic module 730 and the base station 80, are identical to the invention as described above. As shown in FIG. 11 and as described, the multiple flip top closure 714 has two openings 720a, 720b and two movable flaps 735a, 735b. This invention further contemplates a flip top closure having more than two openings and associated flaps. Additionally, the housing 712 may include an internal divider 713 that divides the cavity 711. Thus, pills having different dosages of a medicine may be kept in the same housing 712, but still be separated.

Use of the multiple flip top closure 714 is essentially as described above. The difference is that the patient's compliance with the schedule is tracked based upon which switch means 731a, 731b is activated. For example, a patient may be scheduled to ingest a first dose of two pills in the morning and second dose of three pills at night. As shown in FIG. 11, flap 735a is larger than flap 735b. The electronics module 730 is programmed to associate the activation of switch means 731a with a three pill dosage and the activation of switch means 731b with a two pill dosage. The patient will be instructed to remove the second dose of medicine via the large flap 735a at night and the first dose of medicine via the small flap 735b in the morning. The size of the flap 735a, 735b serves as a reminder to the patient whether the dosage is large, three pills, or small, two pills. The flaps 735a, 735b may also be marked with an indicia 736a, 736b such as “PM” and “AM” to assist the patient in using the proper flap. Data regarding the size of the dose taken, based upon which switch means 731a, 731b is activated, is recorded by the electronics module 730.

While specific embodiments of the invention have been described in detail, it will be appreciated by those skilled in the art that various modifications and alternatives to those details could be developed in light of the overall teachings of the disclosure. For example, the container is more pleasing to the eye when the electronic module is maintained in a recess. The electronic module, however, may simply be attached to the container. Accordingly, the particular arrangements disclosed are meant to be illustrative only and not limiting as to the scope of invention which is to be given the full breadth of the claims appended and any and all equivalents thereof.

What is claimed is:

1. A container for containing one or more doses of medicine, said container comprising:
a housing having an wall defining a cavity and having an opening in said wall;
at least one closure sized to fit over said opening and structured to move between a first, closed position and a second, open position;
a sensor structured to detect when said at least one closure moves between said first closed position and said second open position and produce a sensor signal;
an electronic module having a processing means, a communication means, and a sensor interface; and
said electronic module coupled to said sensor and receiving said sensor signal from said sensor regarding the position of said at least one closure.

2. The container of claim 1, wherein said housing includes a label having indicia regarding the operation of said electronic module.

3. The container of claim 2, wherein said indicia includes at least one scanable symbol.

4. The container of claim 1, wherein said communication means is a speaker.

5. The container of claim 1, wherein said communication means is a liquid crystal display.

6. The container of claim 5, wherein:
said electronic module includes a data storage means structured to contain information regarding a schedule for dosing said medicine;
said communications means provides additional information regarding said medicine and said schedule;
said housing includes a label; and
said label includes a button means for controlling said communication means.

7. The container of claim 1, wherein said processing means includes signaling/receiving means for transmitting/receiving data to/from a destination.

8. The container of claim 7, wherein said signaling means is via wireless communication.

9. The container of claim 7, wherein said destination is a networked communication medium.

10. The container of claim 7, wherein said destination is a receiving means of at least one other of said containers.

11. The container of claim 1, wherein said processing means includes an electronic data storage means for storing data, a controller means, a sensor interface for receiving said sensor signal, a timing means for tracking time, a display interface, and an input/output interface.

12. The container of claim 11 wherein said data storage means is structured to include data representative of a medicine, a dosage schedule and a dispensing history.

13. The container of claim 12 wherein:
said display interface is coupled to said communication means;
said controller means is structured to retrieve data from said data storage means and pass said data to said communication means via said display interface; and
said controller means is structured to generate data from said sensor signal and pass said sensor data to said storage means.

14. The container of claim 13, wherein said communication means is structured to indicate the data selected from the group consisting of showing time until the next dose, visually and/or audibly indicating a prescribed time to dose, verifying dose was taken, warning of a double dosing, notifying of missed dose with corrective action, indicating a data-transmission mode.

15. The container of claim 1 wherein said housing includes at least one outwardly opening recess.

16. The container of claim 15 wherein said electronic module is disposed in said at least one recess.

17. The container of claim 1, wherein said sensor means includes:
a switch means disposed on said housing in a position to interact with said at least one closure;
a switch actuator disposed on said at least one closure; and
said switch actuator and said switch means structured to interact with each other when said at least one closure moves between said first position and said second position.

18. The container of claim 17, wherein:
said switch means is dome switch; and
said actuator is a rigid member structured to trigger said dome switch as said at least one closure moves between said open position and said closed position.

19. The container of claim 18, wherein:
said at least one closure is a rotatable cap having a first threaded portion;
said housing having a second threaded portion disposed about said opening;
wherein said first threaded portion and said second threaded portion are structured to engage each other;
said actuator disposed adjacent to said first threaded portion; and
said dome switch disposed adjacent to said second threaded portion.

20. The container of claim 18, wherein:
said at least one closure is a flip-top lid structured to be disposed over said opening and having a stationary portion and a pivoting flap;
said switch means coupled to said stationary portion; and
said actuator coupled to said pivoting flap.

21. The container of claim 18, wherein:
said at least one closure is a snap-fit lid structured to be disposed over said opening and having a discontinuous flange;
said opening having a complimentary discontinuous flange;
said switch means disposed adjacent to said opening flange; and
said actuator disposed adjacent to said lid flange.

22. The container of claim 18, wherein:
said opening defines a plane and is encircled by a flange;
said at least one closure has a spray nozzle sealingly engaging said opening and structured to move in a direction generally perpendicular to said plane of said opening;
wherein said first position is distal to said opening and said second position is proximal to said opening;
said switch means disposed on said housing between said flange and said nozzle; and
said actuator disposed on said nozzle proximal to said switch and structured to engage said switch as said nozzle moves from said first position to said second position.

23. The container of claim 18 wherein:
said container is a box structured to hold medicine;
said container having a plurality of sides, one of said sides having an opening therein;
said at least one closure includes a flap coupled to one of said sides and disposed adjacent to said opening;
said flap structured to move between a closed position wherein said flap covers said opening and an open position wherein said flap does not cover said opening; and
said dome switch disposed on one of said sides and said actuator disposed on said flap.

24. The container of claim 18, wherein:
said at least one closure is multiple flip top lid structured to be disposed over said opening and having a stationary portion and least two pivoting flaps and at least two switch means;
one said switch means coupled to said stationary portion adjacent to each pivoting flap; and
said at least one actuator coupled to said at least one pivoting flap.

25. The container of claim 1 wherein:
said container is a blister pack having a first plastic layer, a conductive foil layer, a spring action cell foam layer, and a second plastic layer;
said first plastic layer having a plurality of pockets each sized to contain at least one dose of medicine;
said conductive foil disposed between said first plastic layer and said spring action cell foam layer;
said spring action foam layer structured to be collapsible upon application of finger pressure;
said second plastic layer having a plurality of openings corresponding to the locations of said pockets;
said second plastic layer having tines adjacent to said openings projecting toward said first plastic layer;
said tines having a conductive surface;
said electronic module having a battery;
a wire coupled to each said tine conductive surface;
said sensor means including said conductive foil, said conductive surface, and said electronic module battery;
said spring action foam layer disposed between said conductive foil and said second plastic layer;
said conductive foil and said conductive surface held in a spaced relation by said spring action foam layer, thereby forming an open circuit; and
whereby said sensor is structured to detect a short in said circuit when a user squeezes said blister pack causing said second plastic layer to move toward said first plastic layer, while collapsing said spring action foam layer, and causes said tine conductive surface to contact said conductive foil layer closing said circuit.

26. A base station apparatus structured to receive one or more of the containers of claim 1 therein, said base station comprising:
a body having at least one receptacle formed therein, said receptacle being structured to receive said container therein;
a coupling means for establishing an electronic signal link between said receptacle and said received container; and,
base station communication means for conveying data between said container and a communications medium.

27. The base station of claim 26, wherein said base station communication means is a modem connection.

28. The base station of claim 26, wherein said base station communications medium is a networked medium.

29. A method of using a container to aid in medication compliance, said method comprising the steps of:
a) providing a housing with an wall defining a cavity and having an opening in said wall;
b) providing at least one closure structured to move between a first position and a second position;
c) coupling a sensor, structured to detect when said at least one closure moves between said first position and said second position and a produce sensor signal, to said housing and/or said at least one closure;
d) providing an electronic module having a processing means structured to be coupled to said sensor and to receive said sensor signal from said sensor regarding the position of said at least one closure and a display means;
e) providing a label;
f) coupling said label to said electronic module;
g) encoding said label with an identification number;
h) determining a schedule use of said medicine for a patient;
i) encoding said electronic unit with said schedule;
j) providing information relating to said patient and said medicine on said label;
k) coupling said label to said housing so that said electronic module is seated in said recess and said electronic module is coupled to said sensor;
l) placing said medicine in said housing;
m) coupling said at least one closure to said housing thereby forming a closed container;
n) delivering said container to said patient; and
o) said patient using said medicine.

30. The method of claim 29 wherein said determining said schedule step includes the step of a doctor prescribing the use of said medicine.

31. The method of claim 28 wherein said encoding the electronic module step includes the steps of:
a) providing a base station having at least one receptacle structured to receive said container, said cavity having a coupling means for establishing an electronic signal link between said receptacle and said received container;
b) depositing said housing in said base station receptacle; and
c) transmitting data indicative of said schedule through said base unit to said electronic module.

32. The method of claim 31 wherein said step of said patient using said medicine includes the steps of:
a) providing said base station with a communications means;
b) having said base station communications means contact said patient via a pager or telephone; and
c) said patient taking said medicine.

33. The method of claim 29 wherein said encoding the electronic module step is performed by a pharmacist.

34. The method of claim 29 wherein said encoding the electronic module step is performed by a physician.

35. The method of claim 29 wherein said encoding the electronic module step is performed by a medicine manufacturer.

36. The method of claim 29 wherein said step of said patient using said medicine includes the steps of:
a) said electronic module providing a visual and/or audio indication to said patient as to when said medicine should be taken; and
b) said patient taking said medicine.

37. The method of claim 29 wherein said step of said patient using said medicine includes the steps of:
a) said electronic module providing a visual and/or audio indication to said patient as to when said medicine should be taken;
b) said patient not opening said at least one closure; and c) said electronic module providing a visual and/or audio indication to said patient that said patient has missed a scheduled dosage and how said patient should respond to said missed dosage.

38. The method of claim 29 wherein said step of said patient using said medicine includes the steps of:
a) said electronic module recording data relating to the opening and closing of said container;
b) placing container in said base station;
c) said container transmitting said recorded data to said base station; and
d) said base station transmitting said recorded data to a communication medium.

39. The method of claim 29 further including the steps of:
a) providing an electronic database having patient information;
b) providing access, via a computer, to said database to doctors and pharmacists;
c) providing said base stations to pharmacists;
d) providing a communication medium linking said computers and said base unit;
e) said doctor entering said prescription information into said electronic database; and
f) said pharmacist accessing said prescription information from said electronic database.

40. The method of claim 35 further including the step of:
a) transmitting said recorded data to said database; and
b) said doctor accessing said recorded data.

41. The method of claim 28 wherein:
said closure includes a multiple flip top lid having at least two openings, at least two flaps covering said at least two openings and structured to move between a first position and a second position, each said flap having an actuator structured to engage a sensor, and at least two sensors, one sensor associated with each said flap, each said sensor structured to be engaged by said actuator as said flap is moved between said first position and said second position;
said encoding step including the step of associating a first dosage with one of said at least two sensors and associating a second dosage with another of said at least two sensors; and
said step of said patient using said medication includes the steps of:
a) said patient taking a first dose from one of said at least two openings by lifting said flap covering said opening;
b) said patient taking a second dose from another one of said at least two openings by lifting said flap covering said other opening; and
c) said electronic module recording data relating to which said opening said patient moved from said first position to said second position.
